(19) United States
(12) Patent Application Publication
(10) Pub. No.: US 2017/0212601 A1
(43) Pub. Date: Jul. 27, 2017

(54) DEVICE, DEVICE CONTROL METHOD

(71) Applicant: Motomu FUJIKAWA, Shizuoka (JP)

(72) Inventor: Motomu FUJIKAWA, Shizuoka (JP)

(21) Appl. No.: 15/500,465

(22) PCT Filed: May 10, 2015
(86) PCT No.: PCT/JP2015/063395

§ 371 Date: Jan. 30, 2017

(30) Foreign Application Priority Data
Aug. 4, 2014 (JP) 2014-159084
Aug. 29, 2014 (JP) 2014-176509

(51) Int. Cl. G06F 3/01; G06K 9/00; G06F 3/03; G06F 3/0488; H04N 5/232

(52) U.S. Cl. CPC G06F 3/017; G06F 3/0488; H04N 5/23219; G06F 3/0304; G06K 9/00335; G06F 2203/04101; G06F 2203/04808; H04N 5/232

(57) ABSTRACT

A touch panel that can detect variations in electrostatic capacity in three-dimensional space detects variations in the electrostatic capacity of the gestures of a photographer, and an input unit performs acquisition. A lens adjustment unit performs focusing as a result of the recognition by a gesture recognition unit of a gesture wherein the thumb and the forefinger of the photographer are apart, an imaging unit performs shutter release as a result of the recognition of a gesture wherein the thumb and the forefinger of the photographer are brought into contact, the lens adjustment unit performs zooming as a result of the recognition of a gesture wherein the thumb and the forefinger of the photographer are rotated while apart, a light-emission unit turns a flash on as a result of the recognition of a gesture wherein one hand of an operator goes from clasped to open, and the light-emission unit turns the flash off as a result of the recognition of a gesture wherein one hand of the operator goes from open to clasped.

### FIELD OF THE INVENTION

The present invention relates to gesture control.

### BACKGROUND ART

There exist cameras that are operated via gesture control. For example, a camera may take a photograph upon recognizing a single complete “OK” gesture.

### PRIOR ART LITERATURE

### Patent Literature

Patent document 1: Unexamined Japanese Patent Application Publication No. 2013-235588

### SUMMARY OF THE INVENTION

### Problem to be Solved by the Invention

The method for taking photographs with typical cameras is to slightly bend the index finger and depress a shutter button. Users accustomed to this method of operation found it unintuitive to take a photo by holding up a single complete “OK” gesture. The problem would also occur that a photographer didn't realize the range within which the device is capable of recognizing gestures, and the device would take a photograph the moment the “OK” gesture entered the space recognizable by the device, resulting in a mismatch in the photograph timing intended by the photographer and the timing at which the device actually took the photo. Another problem is that a photograph would be unintentionally taken if a clenched fist was recognized as an “OK” gesture.

Therefore, the present invention provides a gesture-controlled device that allows for intuitive operation.

### Means for Solving the Problem

The present invention provides a photography device that takes a photograph upon recognizing a gesture of a photographer, the device being characterized in being provided with:

an input unit for receiving the gesture;

a recognition unit for recognizing the gesture received by the input unit; and

a photographing unit that takes a photograph when the recognition unit recognizes a gesture of a thumb and index finger of one hand of the photographer being brought from an out-of-contact state into contact with each other.

The present invention also provides a method for controlling photography device that takes a photograph upon recognizing a gesture of a photographer, the method being characterized in comprising:

an input step in which an input unit receives the gesture;

a recognition step in which a recognition unit recognizes the gesture received by the input unit; and

a photographing step in which a photographing unit takes a photograph when the recognition unit recognizes a gesture of a thumb and index finger of one hand of the photographer being brought from an out-of-contact state into contact with each other.

The present invention also provides an identification device for identifying gesture-activated shutter release operations, the device being characterized in being provided with:

an identification unit that identifies a gesture of a thumb and index finger of one hand of an operator being brought from an out-of-contact state into contact with each other as a shutter release operation.

The present invention also provides a method for controlling an identification device for identifying gesture-activated shutter release operations, the method being characterized in comprising:

an identification step in which an identification unit identifies a gesture of a thumb and index finger of one hand of an operator being brought from an out-of-contact state into contact with each other as a shutter release operation.

### Effect of the Invention

Intuitive operation is thus made possible. In addition, it is possible to provide an intuitively operable device, and a control method and program for the same.

### BRIEF DESCRIPTION OF THE DRAWINGS

FIG. 1 is an external view of a front face of a smartphone terminal constituting a photograph device,

FIG. 2 is an external view of a rear face of a smartphone terminal constituting a photograph device.

FIG. 3 is an illustration of the configuration of a smartphone terminal 100.

FIG. 4 is a first smartphone operational flow chart.

FIG. 5 is a second smartphone operational flow chart.

FIG. 6 is an illustration of a gesture in which a thumb and an index finger are out of contact

FIG. 7 is an illustration of a gesture in which a thumb and an index finger are in contact.

FIG. 8 is an illustration of a gesture of rotating with a thumb and an index finger out of contact

### BEST MODE FOR EMBODYING THE INVENTION

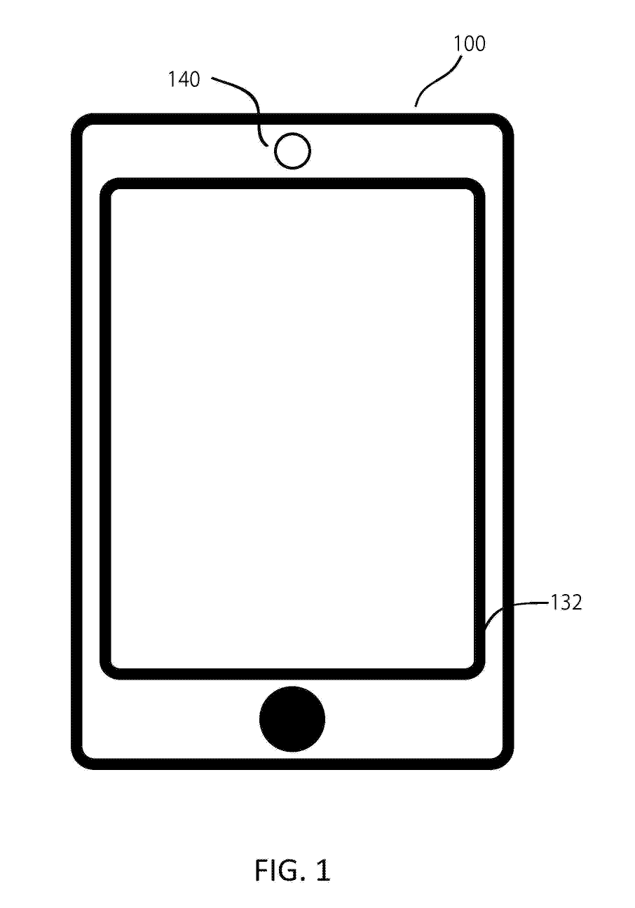

FIG. 1 is an external view of a front face of a smartphone terminal constituting a photograph device according to an embodiment of the present invention. As shown in FIG. 1, a smartphone terminal 100 comprises a touch panel 132 and a photographer lens 140 disposed within a housing.

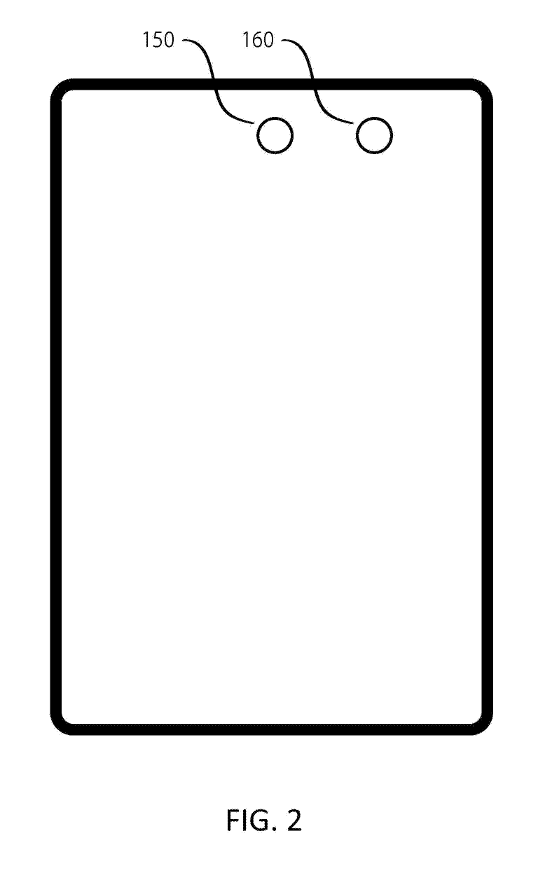

FIG. 2 is an external view of a rear face of the smartphone terminal. As shown in FIG. 2, the smartphone terminal 100 comprises an objective lens 150 and a flash device 160.

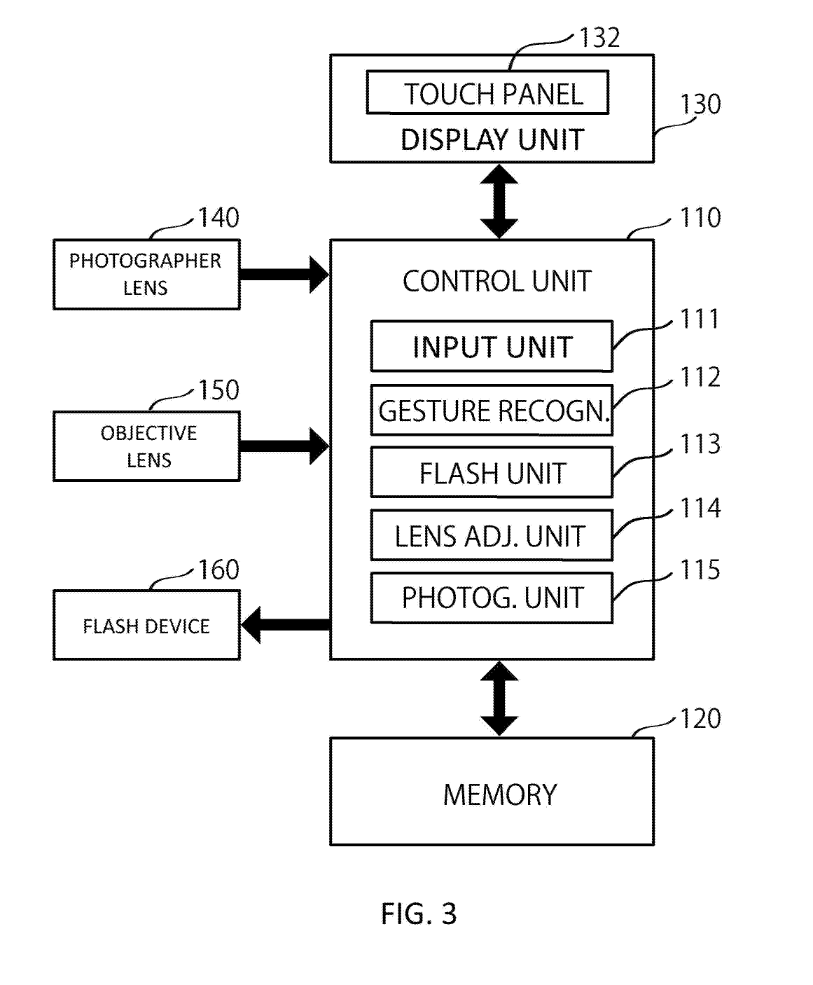

FIG. 3 is an illustration of the configuration of the smartphone terminal 100. As shown in FIG. 3, the smartphone terminal 100 comprises a control unit 110, memory 120, a display unit 130, a photographer lens 140, the objective lens 150, and the flash device 160.

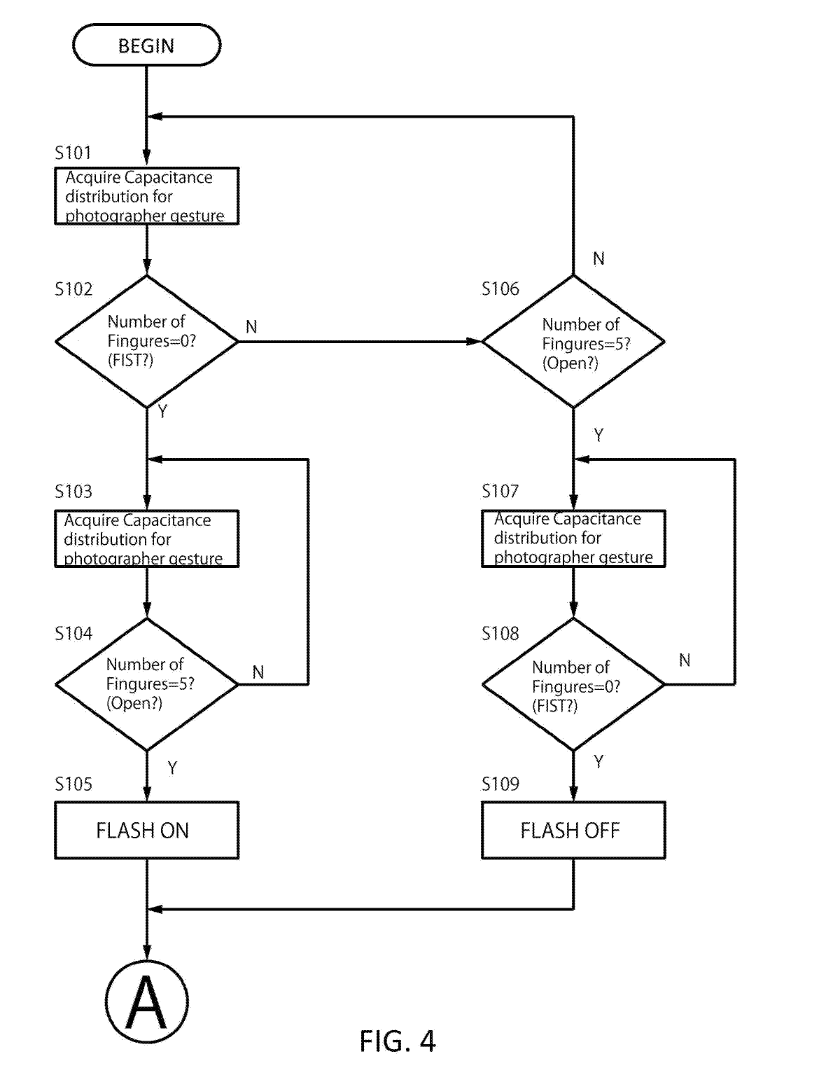

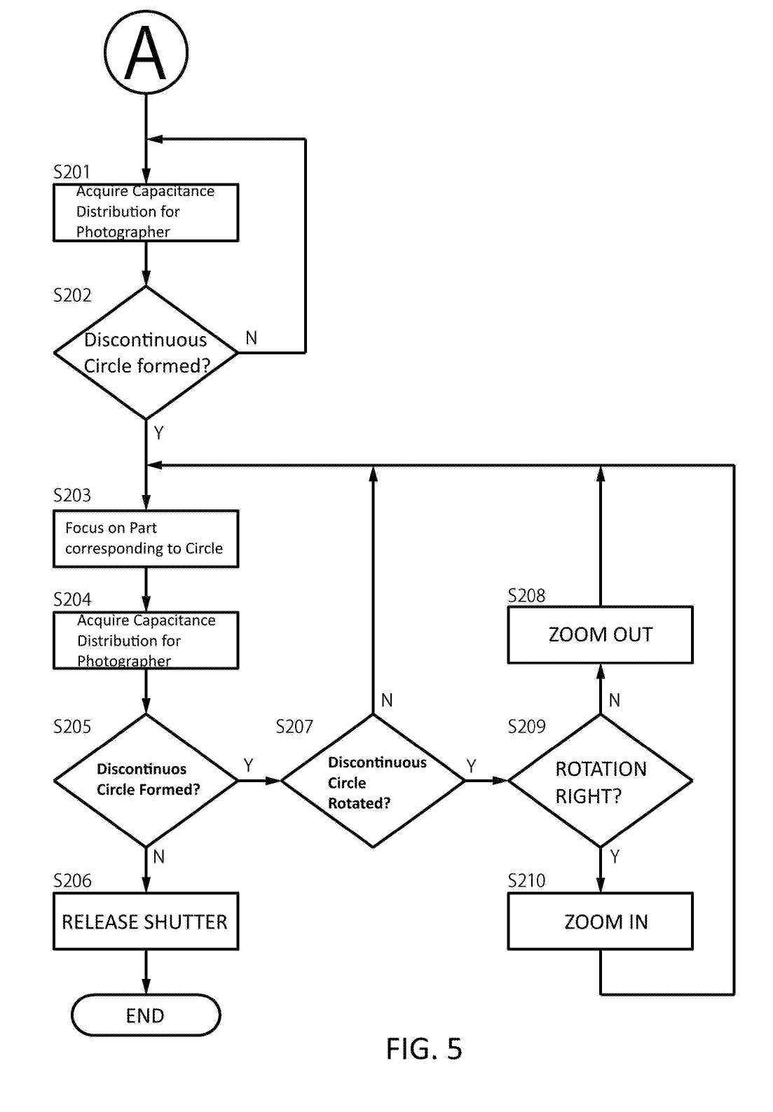

The control unit 110 is constituted by a central processing unit (CPU). The control unit 110 controls various functional parts (input unit 111, gesture recognition unit 112, flash unit 113, lens adjustment unit 114, photographing unit 115, etc.) with which the smartphone terminal 100 is provided by executing software processes according to a program (such as the program for operating the smartphone terminal 100 shown in FIGS. 4 and 5) stored in the memory 120.

The memory 120 is, for example, random access memory (RAM) or read-only memory (ROM). The memory 120 stores various types of information (programs, etc.) used to control the smartphone terminal 100.

The display unit 130 comprises a touch panel 132. The touch panel 132 is constituted, for example, by a liquid crystal display (LCD), plasma display panel (PDP), electroluminescent (EL) display, or the like. The display unit 130 displays images according to an image signal outputted by the control unit 110.

The touch panel 132 is a touch panel capable of recognizing three-dimensional operations, and, when a photographer performs an operation using a finger or the like, detects said operation as three-dimensional coordinates. The touch panel 132 is, for example, a capacitive touch panel that is capable of three-dimensionally detecting the position of the finger, etc., of the user through chances in capacitance when the photographer performs the operation.

A coordinate system constituted by orthogonal axes x-y-z is set for the touch panel 132. The touch panel 132 detects positional coordinates in the form of an x-coordinate, a y-coordinate, and a z-coordinate in the x-y-z coordinate system. The z-coordinate on the surface of the touch panel 132 is 0. The touch panel 132 also outputs positional coordinate information to the control unit 110.

The photographer lens 140 is disposed facing the photographer on the housing of the smartphone terminal 100, and acquires images of gestures performed by the photographer and sends the images to the control unit 110.

The objective lens 150 is disposed on the opposite side of the housing of the smartphone terminal 100 from the photographer lens 140, and acquires images of an object and sends the images to the control unit 110.

The flash device 160 is disposed on the housing of the smartphone terminal 100 facing the same direction as the objective lens 150, and, when a shutter release is performed, simultaneously flashes to illuminate the object.

Next, the operation of the smartphone terminal 100 will be described. FIGS. 4 and 5 are flow charts showing the operations performed when taking a photograph using the smartphone terminal 100.

When the approach of a finger, etc., of a photographer has been detected, the touch panel 132 outputs information for positional coordinates in the x-y-z coordinate system of the touch panel 132 to the control unit 110. The input unit 111 within the control unit 110 acquires positional coordinates in the x-y-z coordinate system of the touch panel 132 at predetermined time intervals (S101). The acquired positional coordinates are stored in the memory 120.

When the gesture recognition unit 112 within the control unit 110 judges that one hand of the photographer has gone from a clenched-fist state like “rock” in rock-paper-scissors to an open-palm state like “paper” in rock-paper-scissors, the gesture recognition unit 112 sends a signal to the flash unit 113. This gesture intuitively suggests light radiating from the flash device 160.

Specifically, the gesture recognition unit 112 detects the edges of the hand based on a capacitance distribution acquired from the input unit 111, and judges whether the number of fingers is zero. If the gesture recognition unit 112 judges that the number of fingers is zero (S102: Yes), positional coordinates are acquired again (S103), if the gesture recognition unit 112 judges that the number of fingers is five (S104: Yes), a signal is outputted to the flash unit 113.

Upon receiving the signal from the gesture recognition unit 112, the flash unit 113 enters a flash-enabled state (S105).

When the gesture recognition unit 112 within the control unit 110 judges that one hand of the photographer has gone from an open-palm state to a clenched-fist state, the gesture recognition unit 112 sends a signal to the flash unit 113. This gesture intuitively suggests the convergence of light radiating from the flash device 160.

Specifically, if the gesture recognition unit 112 judges, on the basis of the capacitance distribution acquired from the input unit 111, that the number of fingers is five (S106: Yes), positional coordinates are acquired again (S107); if the gesture recognition unit 112 judges that the number of fingers is zero (S108: Yes), a signal is outputted to the flash unit 113.

Upon receiving the signal from the gesture recognition unit 112, the flash unit 113 enters a flash-disabled state (S109).

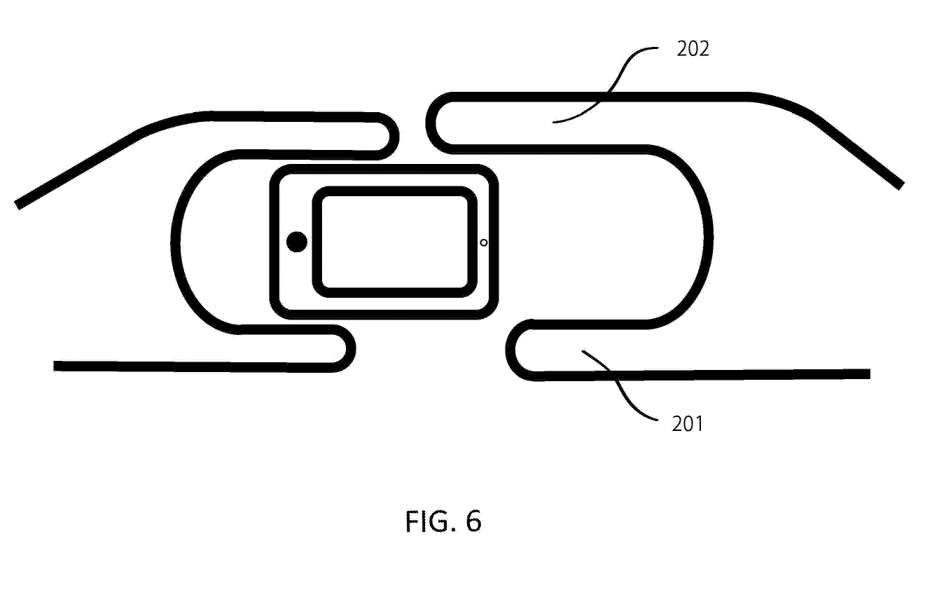

When the gesture recognition unit 112 within the control unit 110 judges that a thumb 201 and an index finger 202 of one hand of a photographer are out of contact with each other (FIG. 6), a focus adjustment signal is outputted to a lens adjustment unit 114.

Specifically, the gesture recognition unit 112 uses the Hough transform, pattern matching, or the like to judge, on the basis of the capacitance distribution acquired from the input unit 111 (S201), whether or not the capacitance of the circle formed by the thumb 201 and index finger 202 of the photographer is discontinuous (S202). If the circle formed by the thumb 201 and index finger 202 of the photographer is discontinuous (S202: Yes), the gesture recognition unit 112 outputs a focus adjustment signal to the lens adjustment unit 114.

Upon receiving a focus adjustment signal from the gesture recognition unit 112, the lens adjustment unit 114 adjusts the focus to a range of an object corresponding to the range bounded by the thumb and index finger of the photographer (S203).

Specifically, upon receiving a signal from the gesture recognition unit 112, the lens adjustment unit 114 adjusts the objective lens 150 to maximize the contrast between an image acquired from the objective lens 150 and displayed on the display unit 130, and a range in which the z-coordinate of the three-dimensional circle formed by the thumb and index finger of the photographer is 0. This range includes the space between the tips of the thumb and index finger.

The input unit 111 within the control unit 110 again acquires positional coordinates (S204). The gesture recognition unit 112 judges, on the basis of the capacitance distribution acquired from the input unit 111, whether or not the capacitance of the circle formed by the thumb and index finger of the photographer is discontinuous (S205).

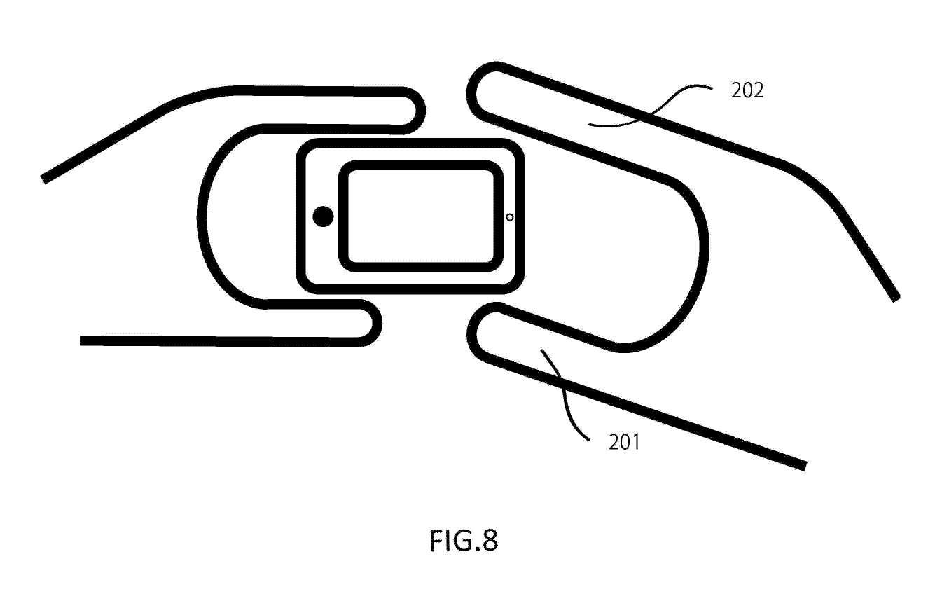

When the gesture recognition unit 112 within the control unit 110 judges that the thumb and index finger of one hand of the photographer are out of contact with each other and the hand of the photographer has been rotated (FIG. 8), the gesture recognition unit 112 outputs a zoom-in signal zoom-out signal to the lens adjustment unit 114.

This gesture intuitively suggests the action of a photographer rotating a zoom ring on a camera with a telescope lens.

Specifically, the gesture recognition unit 112 identifies, on the basis of the capacitance distribution acquired from the input unit 111, the discontinuous part of the circle formed by the thumb and index finger of the photographer and the center of the circle, and judges whether the circle has rotated (S207).

If the gesture recognition unit 112 judges that a discontinuous circle has rotated right (FIG. 8) (S209: Yes), the gesture recognition unit 112 outputs a zoom-in signal to the lens adjustment unit 114.

If the gesture recognition unit 112 judges that a discontinuous circle has rotated left (S209: No), the gesture recognition unit 112 outputs a zoom-out signal to the lens adjustment unit 114. The outputting of the zoom-in signal and the zoom-out signal may also be reversed.

Upon acquiring a zoom-in signal or a zoom-out signal from the gesture recognition unit 112, the lens adjustment unit 114 zooms in or zooms out.

Specifically, upon acquiring a zoom-in signal or a zoom-out signal from the gesture recognition unit 112, the lens adjustment unit 114 adjusts the objective lens 150 to zoom in (S210) or zoom out (S208). Digital zooming may also be employed.

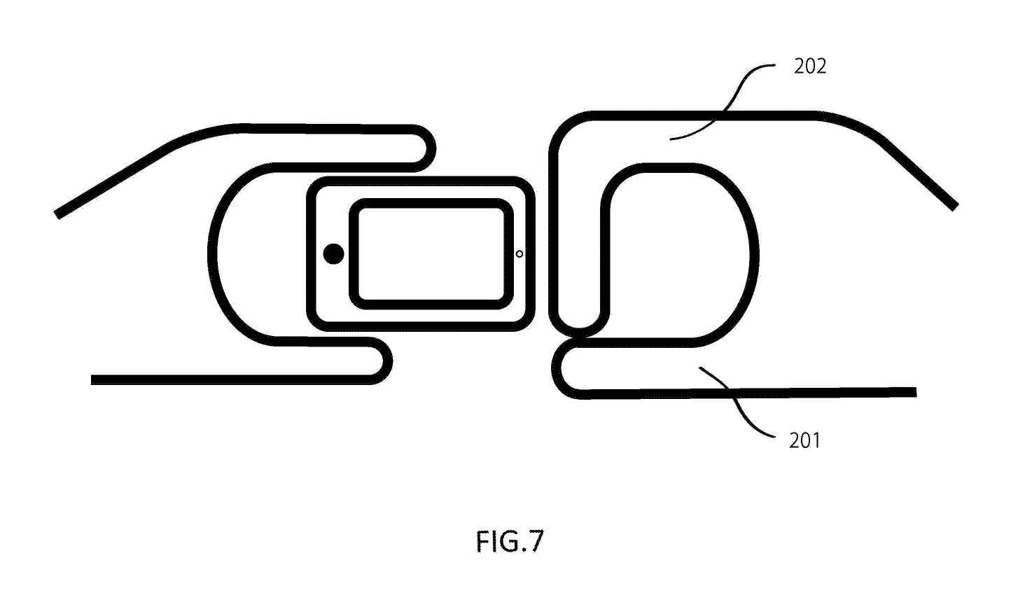

When the gesture recognition unit 112 within the control unit 110 judges that the thumb and index finger of the photographer are in contact with each other (FIG. 7), the gesture recognition unit 112 outputs a photograph signal to the photographing unit 115. Although the thumb and index finger do not touch when the shutter of a still camera is operated, this gesture intuitively suggests the operation of the shutter of a still camera, and allows the desired timing at which the shutter is to be released (the instant at which the thumb and index finger touch) to be clearly ascertained.

Specifically, the gesture recognition unit 112 judges, on the basis of the capacitance distribution acquired from the input unit 111, whether or not the circle formed by the thumb and index finger of the photographer is discontinuous.

If the circle is discontinuous (S205: No), the gesture recognition unit 112 outputs a photograph signal to the photographing unit 115.

Upon receiving the signal outputted by the gesture recognition unit 112, the photographing unit 115 acquires releases an electronic shutter (S206) and acquires an optical image of an object from the objective lens 150, and stores the optical image in the memory 120 as electronic data.

Based on the gesture image acquired by the photographer lens 140 and taken by the photographing unit 115, the gesture recognition unit 112 may recognize the gesture of the photographer, the lens adjustment unit 114 may adjust focus or zoom, and the photographing unit 115 may use the objective lens 150 to photograph the object.

Alternatively, for example, the rotation of the hand in two different planes having the same z-coordinate may be used as a focus operation and a zoom operation, respectively.

The arrangement described above allows flash settings, zoom, focus, and shutter operations to be performed via a single series of operations, thereby decreasing the length of time needed to perform the various operations from setting flash to releasing the shutter. In addition, because the photography device is operated via gestures in three-dimensional space, there is no contact with the device by pressing a shutter button, thus preventing camera shake when taking photographs in real time. In addition, the device can easily be operated by left-handed users. There is also no need to learn developer-defined gestures.

The foregoing has been a description of a preferred embodiment of the present invention; however, the present invention is in no way limited by this specific embodiment, and the scope of the present invention encompasses both the invention set forth in the claims and devices equivalent thereto, such as tablets, cameras, video cameras, wearable terminals, etc.

### REFERENCE NUMBERS

100: Smartphone terminal
110: Control unit
111: Input unit
112: Gesture recognition unit
113: Flash unit
114: Lens adjustment unit
115: Photographing unit
120: Memory
130: Display unit
132: Touch panel
140: Photographer lens
150: Objective lens
160: Flash device
201: Thumb
202: Index finger

1-4. (canceled)

5. An identification device for identifying a gesture as an order for operation comprising:
an identification unit that identifies a transition gesture of fingers of one hand of an operator being brought from a first state into a second state as an instruction to execute a routine of a computer program to perform a function,
wherein the first state is an out-of-contact state of a thumb and an index finger, and the second state is a contact state of a tip of the thumb and a tip of the index finger.

6. The identification device according to claim 5, wherein the computer program is an imaging program.

7. The identification device according to claim 6, wherein the identification unit further identifies a gesture in the first state as an instruction to execute a focusing operation.

8. The identification device according to claim 7, wherein the focusing operation adjusts a focus to a range of an object corresponding to a range bounded by the thumb and the index finger.

9. The identification device according to claim 6, wherein the identification unit identifies a moving gesture of the thumb and the index finger being rotated while keeping the first state as an instruction to execute a focusing operation or a zoom operation.

10. The identification device according to claim 5, further comprising a control unit and a three-dimensional sensor, the three-dimensional sensor detecting the transition gesture and outputting a signal to the control unit.

11. The identification device according to claim 10, wherein the three-dimensional sensor is a capacitance sensor that detects the transition gesture through a capacitance change.

12. An imaging apparatus comprising:
the identification device according to claim 10, a photographing unit, a memory, a touch panel, and an objective lens, the touch panel having the three-dimensional sensor,
wherein the photographing unit acquires an optical image from the objective lens when the identification device identifies the transition gesture, and
the optical image is transmitted to the memory.

13. An identification device for identifying a gesture as an order for operation comprising:
an identification unit that identifies a transition gesture of fingers of one hand of an operator being brought from a first state into a second state as a shutter release instruction,
wherein the first state is an out-of-contact state of a thumb and an index finger, and the second state is a contact state of a tip of the thumb and a tip of the index finger.

14. An imaging apparatus comprising:
the identification device according to claim 13, a photographing unit, a memory, a touch panel, and an objective lens, the touch panel having the three-dimensional sensor,
wherein the photographing unit acquires an optical image from the objective lens when the identification device identifies the transition gesture, and
the optical image is transmitted to the memory.

15. A method for identifying a gesture as an order for operation comprising:
identifying transition gesture of fingers of one hand of an operator being brought from a first state into a second state as an instruction to execute a routine of a computer program to perform a function,
wherein the first state is an out-of-contact state of a thumb and an index finger, and the second state is a contact state of a tip of the thumb and a tip of the index finger.

16. The method according to claim 15, wherein the computer program is an imaging program.

17. The method according to claim 16, wherein a gesture in identified as an instruction to execute a focusing operation.

18. The method according to claim 17, wherein the focusing operation adjusts a focus to a range of an object corresponding to a range bounded by the thumb and the index finger.

19. The method according to claim 16, wherein a moving gesture of the thumb and the index finger being rotated while keeping the first state is identified as an instruction to execute a focusing operation or a zoom operation.

20. The method according to claim 15, further comprising
acquiring an optical image from an objective lens when the transition gesture is identified by the identifying step, and
transmitting the optical image to a memory.
